(19) United States
(12) Patent Application Publication
(10) Pub. No.: US 2010/0191605 A1
(43) Pub. Date: Jul. 29, 2010

(54) System and Method for Managing Account Linkages

(75) Inventors: Todd Nuttall, Gilbert, AZ (US); Troy Bowman, Gilbert, AZ (US); Charmaine Reidhead, Gilbert, AZ (US)

Correspondence Address: ETHERTON LAW GROUP, LLC, 2010 E. University Drive, Suite 25, Tempe, AZ, 85281, US

(73) Assignee: BETTER ATM SERVICES, INC., Mesa, AZ (US)

(21) Appl. No.: 12/686,096

(22) Filed: Jan. 12, 2010

Related U.S. Application Data
(63) Continuation-in-part of application No. 12/058,358, filed on Mar. 28, 2008.
Application No. 12/058,358 is a continuation-in-part of application No. 11/776,382, filed on Jul. 11, 2007.
Application No. 12/058,358 is a continuation-in-part of application No. 11/553,119, filed on Oct. 26, 2006, now abandoned.
Application No. 11/776,382 is a continuation-in-part of application No. 11/553,119, filed on Oct. 26, 2006, now abandoned.
(60) Provisional application No. 61/204,855, filed on Jan. 12, 2009.

(51) Int. Cl. G06Q 40/00

(52) U.S. Cl. 705/17; 705/39; 705/16

(57) ABSTRACT

An account management system allows a prepaid account provider to link a prepaid account to a purchaser of the prepaid instrument used to access the prepaid account. The system uses a prepaid instrument identifier and purchase data collected during the purchase of the prepaid instrument to create the linkage. The purchase data includes information identifying the purchaser, such as the purchaser's account number or name, the purchasing instrument used, the value placed on the prepaid instrument, value-added services requested by the purchaser, and transaction details such as the place and time of purchase. Using the linked prepaid instrument data and purchase data, the prepaid account provider extracts the purchased value from the purchaser's account, opens a prepaid account that is associated with the purchaser and the prepaid instrument, and deposits the purchased value into the prepaid account. The prepaid account provider may track the expenditure of funds from the prepaid account and provide value-added tracking services to the purchaser. The funds remain associated with the purchaser after being deposited in the prepaid account.

### CROSS-REFERENCE TO RELATED APPLICATIONS

This application claims the benefit of co-pending provisional application Ser. No. 61/204,855, filed Jan. 12, 2009, and is a continuation-in-part of co-pending U.S. patent application Ser. No. 12/058,358, filed Mar. 28, 2008, and co-pending U.S. patent application Ser. No. 11/776,382, filed on Jul. 11, 2007, both of which are continuations-in-part of U.S. patent application Ser. No. 11/553,119, filed Oct. 26, 2006, now abandoned.

### FIELD OF INVENTION

This invention relates to electronic financial management. This invention relates particularly to systems and methods for managing the usage of prepaid financial accounts.

### BACKGROUND

In the financial industry, a prepaid account has a stored monetary value, and access to the prepaid account is granted through use of a prepaid instrument, such as a gift card or cash card. The account value may be augmented after an initial purchase. In known systems, the bearer of the prepaid instrument is the only person who can use or add to the funds in the prepaid account. The prepaid account typically has a “closed” or an “open” format. A closed-format account is restricted to use for purchases from specific vendors. For example, a prepaid instrument provider, such as a financial institution or account processor, may issue a Best Buy® gift card that is linked to a prepaid account that will only distribute funds when the gift card is used at a Best Buy® store or website. The gift card may also be authorized for use at Best Buy® subsidiaries such as Geek Squad® and Magnolia Audio Video®. In contrast, an open-format account is not limited to specific vendors. Open-format prepaid instruments are typically issued by or associated with a credit card processor such as American Express® or Visa®.

Prepaid accounts offer consumers financial flexibility in a variety of ways. Consumers may carry a prepaid instrument in lieu of cash, eliminating the hassles of paper money such as damaged or dirty bills, unwieldy wads of bills, piles of change, and currency exchange when traveling. Consumers may also prefer the prepaid instrument to a credit or debit card because the prepaid account contains a limited stored value, capping the financial loss if the prepaid instrument is lost or stolen. Prepaid instruments are also frequently used as gifts, being more flexible than buying a specific item for the recipient, and being more personalized than simply giving cash.

While the financial and other industries have recognized these benefits of prepaid accounts, the full potential of this transaction system has not been realized. Financial institutions and retailers currently provide a vast array of useful tools for customers to manage their non-prepaid accounts, such as online bill pay and account review, purchase protection, incentive programs, lost debit or credit card replacement, and fraud prevention. However, such tools are not provided for prepaid accounts because the prepaid account is not typically associated with the purchasing customer when the prepaid instrument is purchased. It is desirable for an account management system to include prepaid accounts so the prepaid account provider may offer these useful tools to customers that purchase prepaid instruments.

Prepaid accounts typically carry an expiration date. Any unexpended funds remaining at expiration essentially have no owner: the funds do not belong to the prepaid account provider and cannot be traced to the prepaid instrument bearer or to the original purchaser. The unexpended funds typically escheat under the law of the state where the account is held. While some states return a percentage of the funds to the account holder, typically the percentage is 60 percent or less. Further, recovering such funds from the state incurs additional expense. It is desirable to have an account management system that recognizes a prepaid account owner so the unexpended funds are not lost at expiration of the prepaid account.

Therefore, it is an object of the present invention to provide a system and method for managing prepaid accounts by identifying a prepaid instrument purchaser and linking that purchaser with the associated prepaid account. It is a further object to provide value-added servicing of the prepaid account to the linked purchaser. It is another object of the invention to allow unexpended funds in prepaid accounts to be reclaimed at expiration of the account.

### SUMMARY OF THE INVENTION

An account management system allows a prepaid account provider to collect and link data pertaining to a prepaid instrument with data pertaining to the purchase of the prepaid instrument. The prepaid instrument data includes an instrument identifier and may also include the expiration date of the prepaid instrument. The purchase data may include an account identifier for the purchaser's account or other identifying information such as the purchaser's name and the purchasing instrument used, the value placed on the prepaid instrument, value-added services requested by the purchaser, and transaction details such as the place and time of purchase. The account identifier may be obtained in a face-to-face transaction, from a card used to access an automated teller machine (“ATM”), or from the purchaser's purchasing instrument, which is, for example, an ATM card, credit or debit card, cellular telephone, or electronic debit through the prepaid account provider's website. The account identifier may also be obtained after the transaction, such as by receiving it from the purchaser through the internet or telephone.

Using the linked prepaid instrument data and purchase data, the prepaid account provider extracts the purchased value from the purchaser's account, opens a prepaid account that is associated with the purchaser and the prepaid instrument, and deposits the purchased value into the prepaid account. The prepaid account is debited each time the prepaid instrument is used to make a purchase, and only the prepaid instrument may be used to spend the funds in the prepaid account. The prepaid account provider may track the expenditure of funds from the prepaid account and provide value-added tracking services to the purchaser, such as a prepaid account status and usage summary, email notification when the prepaid instrument is used, and incentive programs related to the purchase and usage of the prepaid instrument. The funds remain associated with the purchaser's account and may accrue interest that can be added to the purchaser's account or to the prepaid account. The prepaid account provider may also return the funds in the prepaid account to the purchaser's account, for example at regular intervals or upon expiration of the prepaid instrument, if unused funds remain.

### BRIEF DESCRIPTION OF THE DRAWINGS

FIG. 1 is a diagram of a prepaid account management system according to the present invention.

FIG. 2 is a flowchart showing a method for managing prepaid account linkages from the perspective of the prepaid account provider.

FIG. 3 is a flowchart showing the purchase process of FIG. 2.

FIG. 4 is a diagram of the preferred embodiment of a prepaid account portfolio entry.

FIG. 5 is a diagram of an example visual representation of the prepaid account management system implemented on a website.

FIG. 6 is a diagram of the prepaid account management system described in the “Dumb ATM” example.

FIG. 7 is a front view of a prepaid product sheet dispensed by the ATM of FIG. 6.

FIG. 8 is a flowchart showing the purchase process from the perspective of a smart ATM.

FIG. 9 is a diagram of the prepaid account management system described in the “Over-the-Counter Purchase Using Cash” example.

### DETAILED DESCRIPTION OF THE INVENTION

The present invention includes methods and systems for managing prepaid accounts and the funds associated with them. A prepaid account is a transactional account having a stored value that can be debited through purchases made with an associated prepaid instrument. In one embodiment, the prepaid account is a demand account, meaning it contains funds equal to the stored value, held in the name of the prepaid instrument purchaser or the prepaid account provider. In another embodiment, the prepaid account tracks the stored value and the funds are held in a prepaid holding account, described below.

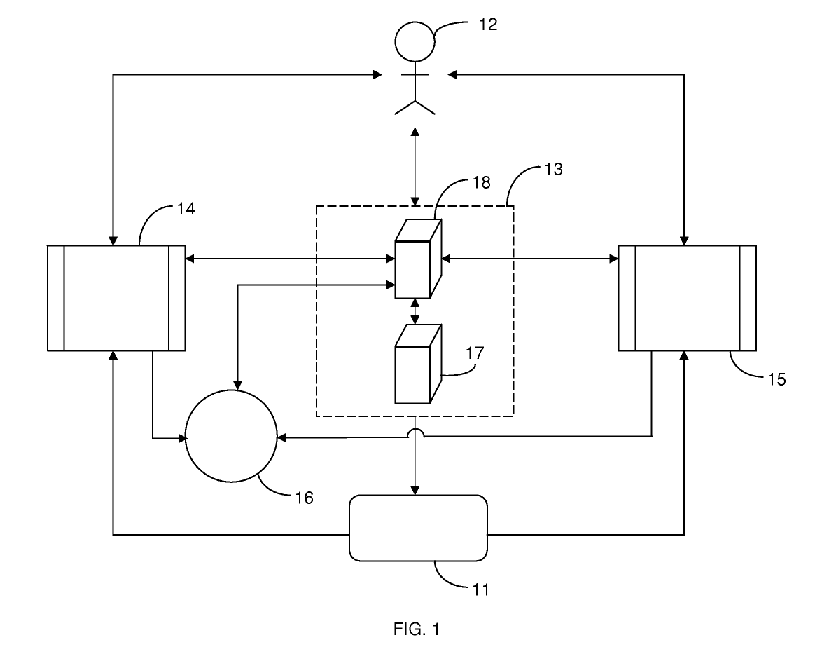

Referring to FIG. 1, a prepaid account provider 13 creates and manages prepaid accounts for its customers. The prepaid account provider 13 may be a financial institution, credit or debit card issuer, gift card management company, online retail entity, or other entity capable of maintaining prepaid accounts. In the preferred embodiment, the prepaid account provider 13 is a financial institution, such as a bank or credit union, where a prepaid instrument purchaser has an existing account that is accessible through an ATM. The prepaid account provider 13 electronically maintains a prepaid account portfolio for each of its customers. The prepaid account portfolio contains each of the customer's prepaid accounts, a prepaid account identifier associated with each prepaid account, and a prepaid account record associated with each prepaid account identifier. The prepaid account record contains information about the prepaid account, including the current stored value of the prepaid account and an instrument identifier for the prepaid instrument used to access the account.

In the preferred embodiment, the prepaid account provider 13 uses the present invention in conjunction with a general account management system. The general account management system includes online access to all of the customer's accounts for retrieval of transaction summaries, bill pay, balance transfers, and other account-related activity. Within the general account management system, each customer has a prepaid account portfolio, which may be stored on the prepaid account provider's 13 central data server 17 or on one or more other computers.

A prepaid instrument processor 16 maintains status records of the prepaid instruments made available by the prepaid account provider 13. The prepaid instrument processor 16 may be completely separate from the prepaid account provider 13, or the two entities may be departments, divisions, or subsidiaries of one company. The status records include the activation status of prepaid instruments that have been purchased. The activation status of each prepaid instrument may be “inactive,” “active,” or “expired,” and may also have a special “flagged” status that may be set if the prepaid instrument is reported lost or is suspected to have been misused. When a purchase is made at a vendor using an active prepaid instrument, the prepaid instrument processor 16 instructs the prepaid account provider 13 to transmit funds to the vendor. The activation status may also include a reference to the stored value accessible by each prepaid instrument. In such an embodiment, the prepaid instrument processor 16 receives notice when the stored value is increased, and may further receive notice when the stored value is decreased.

A prepaid instrument 11 is used to access the funds associated with the prepaid account. The prepaid instrument 11 has a unique instrument identifier that allows the prepaid instrument 11 to be recognized by both the prepaid account provider 13 and the prepaid instrument processor 16. The format of the instrument identifier may depend on the embodiment of the prepaid instrument 11, which may be an access code, a digital certificate, a printed receipt, a ticket, a scannable card, microchip, radio frequency identification (“RFID”), or another type of media capable of storing the instrument identifier. The instrument identifier may be a number, a scannable symbol such as an Aztec Code or other barcode, or an electronic code such as that contained in a magnetic strip, microchip, or RFID. The instrument identifier may be a proxy number, which is typically used in credit card processing to protect the actual account number associated with a credit card. Preferably, the prepaid instrument 11 is a credit-card-size scannable card, having a scannable symbol representing the instrument identifier, and a magnetic strip for swiping at currently-deployed point of sale devices.

The prepaid instrument 11 may have a format that the prepaid account provider 13 or prepaid instrument processor 16 may obtain to determine if the prepaid instrument 11 is accepted by a certain vendor. Prepaid instrument 11 formats include: a single-vendor card that uses a closed-format account and is only accepted at a particular vendor; a vendor-chain card that uses a closed-format account and is accepted at vendors that are partnered according to certain criteria, such as commonly-owned restaurants or subsidiaries of “big box” retailers; and an open-format card that uses an open-format account and may be accepted at any vendor that has agreed to accept it, such as a prepaid VISA® card being accepted anywhere a VISA® payment device can be used. The prepaid account provider 13 or prepaid instrument processor 16 may use the instrument identifier for the prepaid instrument 11 to obtain the format. The prepaid instrument 11 may further be associated with unique incentives, such as product promotions or discounts on certain purchases, which may be obtained by the prepaid account provider 13 or prepaid instrument processor 16 in the same way as the format is obtained. The prepaid instrument 11 may also have a preset expiration date, or the expiration date may be set upon purchase.

The prepaid instrument 11 may be issued by the prepaid account provider 13, the prepaid instrument processor 16, a specific vendor with which the prepaid instrument 11 may be used, or another entity. The prepaid instrument 11 may be made available for purchase by the prepaid account provider 13 or by a separate instrument seller. For example, for single-vendor and vendor-chain cards the instrument seller may be one of the vendors where the cards will be used after activation. In another example, prepaid instruments 11 for many different vendors may be sold at a grocery store or mall kiosk. In the preferred embodiment, the prepaid account provider 13 sells prepaid instruments 11 through an ATM. As described below, sales through existing ATMs are facilitated by a prepaid product inventory manager, which may be the prepaid account provider 13 or a separate entity.

The prepaid instrument 11 must be activated before it can be used to make purchases. In one embodiment, the prepaid instrument 11 is preactivated, meaning the prepaid instrument 11 is activated before or at the same time that the prepaid account provider 13 makes the prepaid instrument 11 available for purchase. In another embodiment, the prepaid instrument 11 is activated upon purchase. In yet another embodiment, the purchaser activates the prepaid instrument 11 after purchase, such as by calling an activation phone number or logging into the prepaid account provider's 13 website and entering the instrument identifier. In yet another embodiment, the prepaid instrument 11 is activated when it is first used to make a purchase, immediately before the purchase is made. Upon activation, the prepaid account provider 13 creates the prepaid account containing the starting value and the prepaid instrument 11 identifier, and the prepaid instrument processor 16 is notified that the prepaid instrument 11 can access the associated funds and the activation status of the prepaid instrument 11 should be changed to “active.”

The prepaid instrument 11 may be sold as part of a prepaid product bundle, such as a book or sheet comprising advertisements, coupons, additional prepaid instruments 11, or other incentives. The prepaid product bundle may have its own unique bundle identifier. At purchase, the bundle identifier is collected, preferably by the prepaid product inventory manager, and preferably using an optical scanner and software installed in the ATM. The prepaid product inventory manager maintains a database of the prepaid product bundles, whereby it can use the bundle identifier to determine the instrument identifiers of the prepaid instruments 11 contained in the prepaid product bundle. The prepaid product inventory manager may activate, or request activation of, the corresponding prepaid instruments 11. Multiple prepaid instruments 11 may be packaged in a single bundle, each prepaid instrument 11 having its own instrument identifier, so that the prepaid instruments 11 may be added separately or simultaneously to one or more prepaid account portfolios as described below.

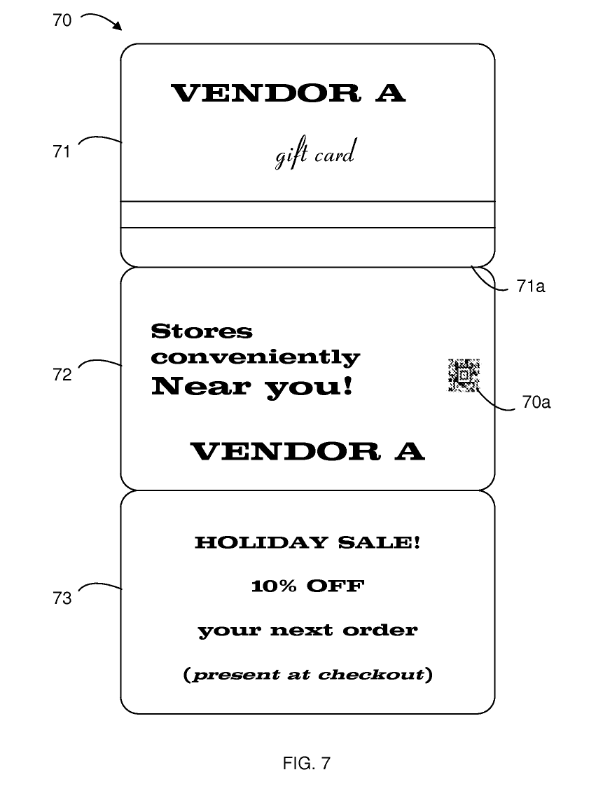

The prepaid product sheet 70, shown in FIG. 7 and described below, is an example of a prepaid product bundle. The prepaid product sheet 70 may have a length, width, and thickness that allow it to be loaded into a standard currency cassette in an ATM. The prepaid product sheet 70 may have one or more credit-card-sized separable portions, one or more of which contain a magnetic strip or other identifier, so that the separable portions may be used like a standard credit card on any standard point of sale device. Preferably, one of the credit-card-sized separable portions is the prepaid instrument 11.

In the preferred embodiment, a purchaser 12 has at least one existing account with the prepaid account provider 13. The purchaser 12 preferably uses one of the existing accounts, referred to herein as the purchaser's 12 account, to purchase the prepaid instrument 11. This allows the prepaid account provider 13 to associate the purchaser 12 with the prepaid account as described below. Alternatively, the purchaser 12 does not use an existing purchaser's 12 account to purchase the prepaid instrument 11, such as when the purchaser 12 pays with cash or when the purchaser's 12 account is a user account that cannot execute financial transactions. In this case, the purchaser 12 may later inform the prepaid account provider 13 of the purchase. For example, the purchaser 12 may telephone the prepaid account provider 13 and orally supply the instrument identifier and purchase data, or the purchaser 12 may access his account portfolio online and manually add the prepaid account to his prepaid account portfolio. This allows the prepaid account provider 13 to associate the purchaser 12 with the prepaid account. A post-purchase association also allows the prepaid account provider 13 to associate a person other than the purchaser 12 with the prepaid account. For example, the purchaser 12 may give the prepaid instrument 11, unactivated, to a recipient who then activates the prepaid instrument 11 by providing her own account information to the prepaid account provider 13. The term “purchaser” as used herein may refer to such a recipient of a non-activated prepaid instrument 11, even though the recipient did not actually purchase it.

During or after purchase of the prepaid instrument 11, the purchaser 12 may customize the associated prepaid account with a variety of options, including but not limited to the initial stored value in the prepaid account, the term before expiration, and the value-added services described below. The purchaser 12 may add these options at the time of purchase, and may further add, change, or remove options later. Preferably, the purchaser 12 makes these changes by accessing his prepaid account portfolio online, as explained below. Alternatively, the prepaid account provider 13 may include some or all of these options, associating them with the prepaid account when the prepaid account is opened or when the prepaid instrument 11 is purchased.

Linking Purchaser with Prepaid Account

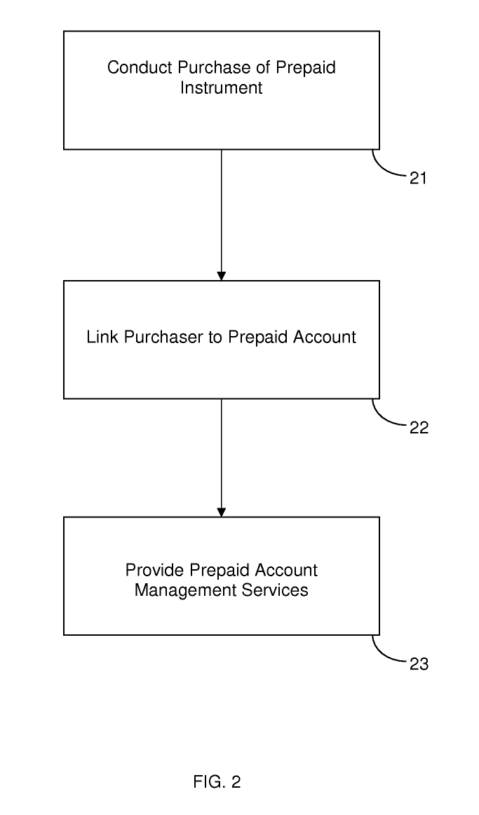

Referring to FIGS. 1 and 2, a purchaser 12 purchases a prepaid instrument 11 at a point of sale (“POS”), which may be an automated POS device 14, such as an ATM, kiosk, vending machine, or website, or the POS may be an over-the-counter POS 15, such as a bank branch or retail or grocery store. During or after the purchase 21, the prepaid account provider 13 receives data identifying the purchaser 12 and an instrument identifier for the prepaid instrument 11. The data identifying the purchaser may be an account identifier for an existing account the purchaser 12 has with the prepaid account provider 13, a credit or ATM card number, the purchaser's 12 name or username, or one or more other pieces of identifying information. Preferably, the data identifying the purchaser 12 is the account identifier for the purchaser's 12 account used to make the purchase 21. The prepaid account provider 13 links 22 the purchaser 12 with the prepaid account associated with the prepaid instrument 11 using the data identifying the purchaser 12 and the instrument identifier. The linkage 22 of the purchaser 12 to the prepaid account allows the prepaid account provider 13 to provide 23 prepaid account management services to the purchaser 12. Data relating to the purchase 21 may also be provided to a prepaid instrument processor 16 to ensure the prepaid instrument 11 is activated and transactions using it are properly processed.

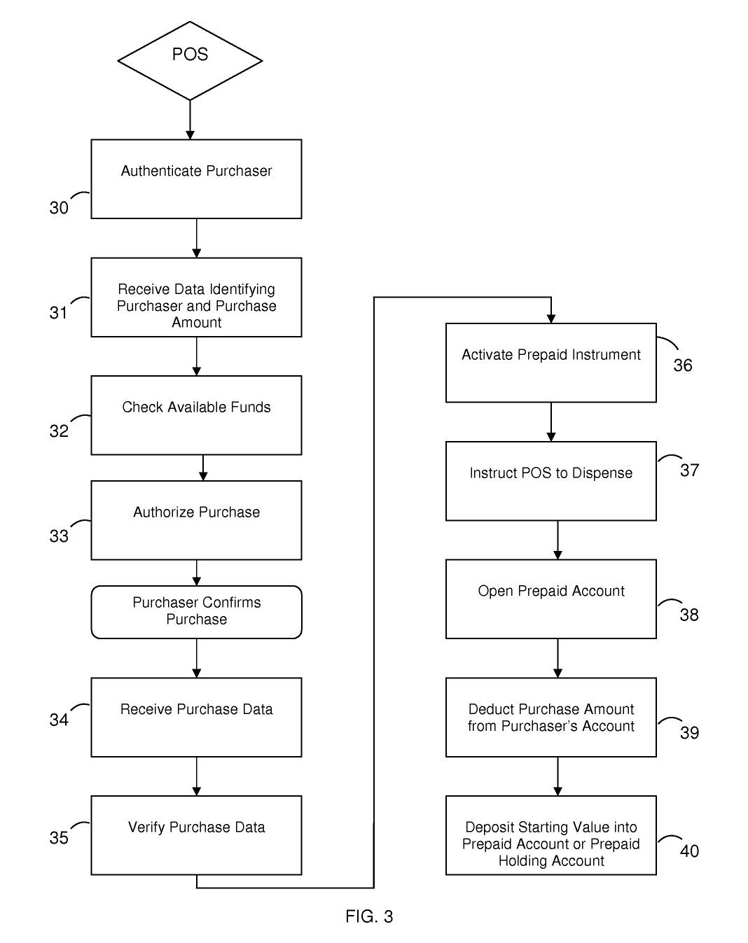

FIG. 3 illustrates an embodiment of the prepaid instrument 11 purchase 21 from the perspective of the prepaid account provider 13. A transaction server 18 (shown in FIG. 1) performs the illustrated steps using software that is configured to operate within the prepaid account provider's 13 computer system. The prepaid account provider 13 first authenticates 30 the purchaser 12. At an ATM, kiosk or vending machine, authenticating 30 may comprise receiving and verifying the purchaser's 12 ATM card and personal identification number (“PIN”). At a website, authenticating may comprise collecting the purchaser's 12 account username and password. In an over-the-counter POS 15 purchase 21, the salesperson may authenticate 30 the purchaser 12 by visually verifying the identity of the purchaser 12, such as by checking a photo identification card of the purchaser 12.

The prepaid account provider 13 receives the data 31 identifying the purchaser 12 and the purchase amount. The purchase amount is the value to be deducted from the purchaser's account. The purchase amount may include the stored value to be placed in the prepaid account, less any discounts offered according to the unique terms of the prepaid instrument, plus any fees for the transaction, value-added services, or incentives, if applicable to the prepaid instrument. It is contemplated that the purchase amount may be considerably higher or lower than the stored value to be placed in the prepaid account, considering that promotions or discounts may be associated with the prepaid instrument 11, and further considering that the invention contemplates the purchase 21 of multiple prepaid instruments at once, as well as the purchase 21 of prepaid product bundles.

If the purchaser's 12 account is used to make the purchase 21, the prepaid account provider 13 checks 32 that the purchaser's 12 account contains sufficient funds to cover the purchase amount. If there are sufficient funds, the prepaid account provider 13 authorizes 33 the purchase 21. When the purchase 21 is executed, the prepaid account provider 13 receives purchase data 34 describing the purchase 12 from one or more of the POS, a transaction processor, and the prepaid products inventory manager (see “Dumb ATM” Example below). The purchase data includes the purchaser's 12 account identifier, the prepaid instrument 11 identifier, and the starting value to be placed in the prepaid account, and may further include transaction details, such as the place and time of purchase, the purchase instrument used to purchase 21 the prepaid instrument 11, and a list of value-added services selected by the purchaser to be used on the prepaid account.

Upon receipt of the purchase data 34, the prepaid account provider 13 may verify 35 the integrity of the purchase data. However, verification 35 of the purchase data is an optional step for added security. If verification 35 is skipped or completed with a report of no errors in the purchase data, the prepaid account provider 13 activates 36 the prepaid instrument 11 by notifying the prepaid instrument processor 16 to create or update its status record for the prepaid instrument 11. The prepaid instrument provider 13 then instructs 37 the POS to dispense the prepaid instrument 11 to the purchaser 12. The prepaid instrument provider 13 then opens 38 the prepaid account, creating a prepaid account identifier. Preferably, the prepaid account identifier is unique to the prepaid account, but alternatively may be the same as the prepaid instrument identifier. The prepaid account provider deducts 39 the purchase amount from the purchaser's 12 account, and deposits 40 the starting stored value into the prepaid account or a prepaid holding account, reserving any applicable fees. The purchase 21 is then considered complete.

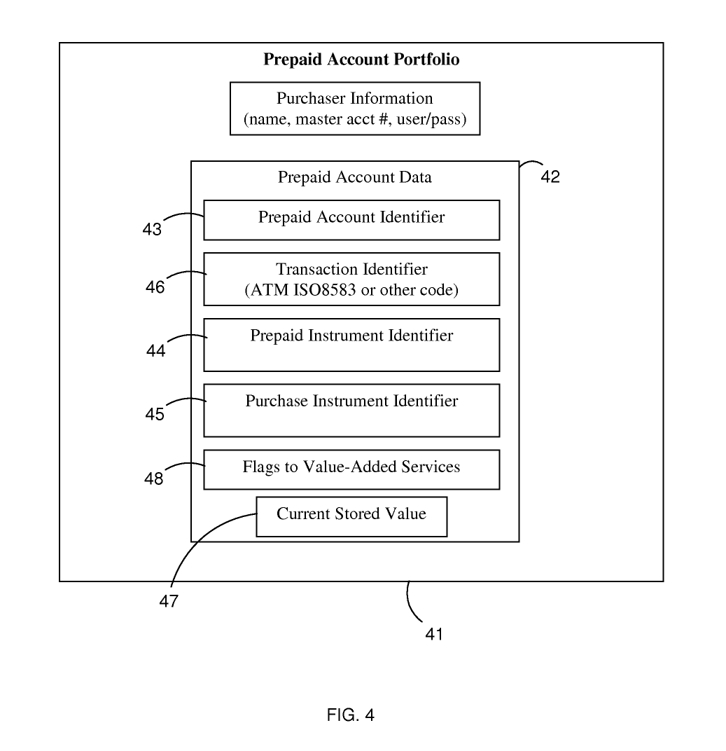

The purchaser 12 is linked 22 to the prepaid account by adding at least the prepaid account identifier to the purchaser's 12 prepaid account portfolio. The prepaid account identifier may be used to look up data pertaining to the prepaid account, which may be stored in other databases. Alternatively purchase data and other relevant data may also be stored in the prepaid account portfolio. FIG. 4 illustrates the preferred embodiment of a prepaid account record 42 created within the prepaid account portfolio 41, wherein the prepaid account record 42 contains the prepaid account identifier 43, the prepaid instrument identifier 44, a purchase instrument identifier 45, a transaction identifier 46 such as one generated by an ATM (see “Dumb ATM” Example below), the current stored value 47, and a flag 48 indicating whether value-added services have been applied.

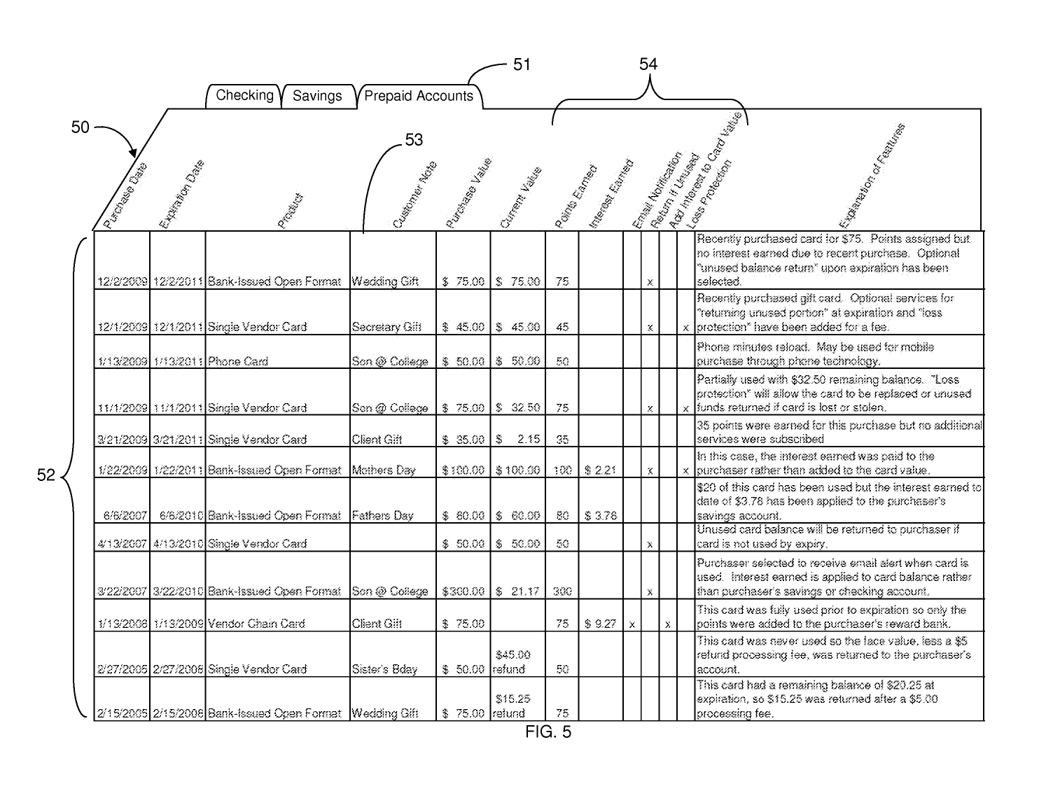

Once the purchaser 12 and prepaid account are successfully linked 22 in the purchaser's 12 prepaid account portfolio, the prepaid account provider 13 can provide 23 prepaid account management services. Preferably, these prepaid account management services are provided 23 to the purchaser over the internet. FIG. 5 illustrates an example display of a visual representation 50 of the purchaser's 12 prepaid account portfolio 41, which the purchaser 12 may see when he logs into the prepaid account provider's 13 website. Choosing the “Prepaid Accounts” tab 51, the purchaser 12 sees a list 52 of all of the prepaid accounts he has open with the prepaid account provider 13. Each prepaid account in the list 52 reports the data contained in or referenced by the prepaid account record 42 associated with that prepaid account. Using the website, the purchaser 12 can add funds to the prepaid account, enter a prepaid account description 53, and add or remove value-added services 54. The method of linking 22 the purchaser 12 to the prepaid account enables known and novel value-added services to be included with the purchase of a prepaid instrument, including but not limited to those value-added services described below.

Retention of Rights to Value

The present invention may be used to prevent loss of prepaid account funds. This loss may be due to escheatment when the prepaid instrument 11 expires, or due to loss or fraudulent use of the prepaid instrument 11. In the present invention, the starting value of the prepaid account is debited from the purchaser's 12 account when the prepaid instrument 11 is purchased 21, but because the prepaid account is linked to the purchaser 12, the funds remain associated with the purchaser. In one embodiment, funds are placed in the prepaid account, where they remain until they are expended or the prepaid instrument 11 is invalidated. This prepaid account is a demand account or an escrow account held in favor of the purchaser 12. In another embodiment, the prepaid account contains a reference to the stored value and keeps track of deposits and debits, but the actual funds are deposited in a prepaid holding account, which is an escrow account held in favor of the prepaid account provider 13, the prepaid instrument 11 issuer, or the vendor with which the prepaid instrument 11 may be used. In either embodiment, the account containing the funds is controlled by the prepaid account provider 13. In contrast to known prepaid instrument systems wherein the funds are transferred to the prepaid instrument processor 16 upon purchase, in the present system funds are only transferred to the prepaid instrument processor 16 or vendor in time to fulfill a purchase made using the prepaid instrument 11. The unexpended funds, or a reference thereto, remain in the prepaid account, and therefore remain associated with the purchaser 12 due to the linkage 22 of the purchaser 12 and the prepaid account.

If the prepaid instrument 11 expires or is lost or stolen before the funds in the prepaid account are exhausted, the prepaid account provider 13 may return the remaining funds to the purchaser's 12 account that is identified in the prepaid account portfolio entry for that prepaid account. In the case of expiration, the prepaid account provider 13 may close the prepaid account and remove it from the purchaser's 12 prepaid account portfolio, and also return any unexpended funds to the purchaser's 12 account. The prepaid account provider 13 would also inform the prepaid instrument processor 16 that the prepaid instrument 11 can no longer be honored. If the prepaid instrument 11 is lost or stolen, the prepaid account provider 13 may provide the purchaser 12 with the option of obtaining a replacement prepaid instrument 11 or closing the prepaid account and having the unexpended funds returned to the purchaser's 12 account. Where the prepaid instrument 11 expires or the purchaser 12 chooses to close the prepaid account associated with a lost or stolen prepaid instrument 11, the prepaid account provider 13 informs the prepaid instrument processor 16 to change the activation status for the prepaid instrument 11 to “expired,” “inactive,” or another appropriate status as the case requires. If fraudulent purchases are made using the card, the prepaid account provider 13 may reimburse the stolen funds to the purchaser's 12 account or to the prepaid account. The prepaid account provider 13 may charge a service fee to return unused or misappropriated funds. Where the prepaid account provider 13 is an FDIC-insured financial institution, the funds in the prepaid account or prepaid holding account may be insured from loss because they are controlled by the institution, as opposed to being controlled by the prepaid instrument processor 16.

The rights to the value of the prepaid account are further retained by managing the accumulation of interest on unexpended funds. Before they are used, the funds remain on the prepaid account provider's 13 balance sheet as an asset, allowing interest to accrue on the funds. The prepaid account provider 13 may return the interest to the purchaser 12 as a value-added service by depositing the interest into the purchaser's 12 account or into the prepaid account. The prepaid account provider 13 may charge a fee for this service. Alternatively, the prepaid account provider 13 may open the prepaid holding account at a separate financial institution in its name and retain the interest on unexpended funds as revenue. It will be recognized that where the prepaid account provider 13 is a financial institution that opens the account at its own institution, “retaining the interest” means paying no interest on the unexpended funds.

Purchase Tracking

In the present invention, when the prepaid instrument 11 is used to make a purchase, the prepaid account provider 13 may receive transaction details describing the purchase. The transaction details may include the date, the amount spent and, if the prepaid instrument 11 is not a single-vendor card, information identifying the vendor. The transaction details may also include a description of what was purchased. The prepaid account provider 13 may provide this information to the purchaser 12, allowing the purchaser 12 to track the usage of the prepaid instrument 11. For example, the purchaser 12 may receive a monthly statement for the prepaid account.

The prepaid account provider 13 may further allow the purchaser 12 to request an alert service, wherein one or more alerts are delivered to the purchaser 12 when the prepaid instrument 11 is used. An alert is a message containing a notification that the prepaid instrument 11 has been used; the alert may further contain some of all of the transaction details. Alerts may be delivered by email, live or automated phone call, text message, or other mode of communication.

Incentive Program

The present invention, as a stand-alone account management system or as a component of a financial institution's general account management system, may use the linking 22 of the purchaser 12 and the prepaid account to provide an incentive program wherein the purchaser 12 earns a certain number of “reward points” corresponding to the amount placed into the prepaid account, the amount debited from the prepaid account, or both. The reward points may be accumulated and traded for goods or services, as is known in the art.

Inflation Management

While some small amount of annual currency inflation is typical, hard economic times or excessive printing of paper money by the government can result in increased inflation or even hyperinflation, where inflation cyclically and drastically increases without any tendency toward equilibrium. In hyperinflationary cycles, paper money may rapidly diminish in value. To counteract increased inflation, the government may institute a reindexing system wherein customers' accounts at financial institutions are adjusted at a predetermined reindexing interval, such as nightly, to partially or fully compensate for currency devaluation caused by inflation. Paper money and untrackable accounts will not receive the adjustment and so will be worth less the next day. Conventional prepaid instruments will suffer this devaluation because they are not tracked.

The present invention provides a system and method for retaining the value in a prepaid account during periods when a reindexing system is instituted. Because the prepaid account is linked 22 to the purchaser 12, the prepaid account provider 13 may track the current value in the prepaid account. At each reindexing interval, the prepaid account provider 13 may deposit the unexpended funds in the prepaid account or prepaid holding account into the purchaser's 12 account. The unexpended funds are then reindexed according to the reindexing system. After reindexing, the prepaid account provider 13 may withdraw the unexpended funds and redeposit them into the prepaid account or prepaid holding account. The funds withdrawn may be equal to the amount deposited for reindexing, or may be the adjusted amount if the prepaid account provider 13 knows the parameters used by the reindexing system. Alternatively, the unexpended funds may be reindexed while they are in the prepaid account or prepaid holding account.

Hedge Instruments

A value-added service similar to inflation management is for a prepaid instrument provider 13 to use the present system and method to provide “hedging” commodity instruments. Rather than an amount of currency, the starting value in the prepaid account may be an amount of a particular commodity, such as gallons of gas, pounds of a particular food, or carbon credits. The commodity is purchased at the market value or a specially set price, and the starting value is debited through use over time. The purchaser 12 thereby overcomes price increases of the commodity while there is value remaining in the prepaid account. Further, by linking 22 the prepaid account to the purchaser 12, the purchaser 12 may track the value remaining on the card and the price at which the commodity was purchased.

Instrument Security

Using the present invention, the prepaid account provider 13 may offer the purchaser 12 the service of requiring authentication of the bearer of the prepaid instrument 11 before the prepaid instrument 11 can be used to make a purchase. For example, the purchaser 12 may assign a PIN to a gift card. In another example, the purchaser 12 may choose to require that the vendor check the bearer's identification before allowing a purchase with the prepaid instrument 11. The alert service described above may also serve as an added security feature.

Example Purchase from Dumb ATM

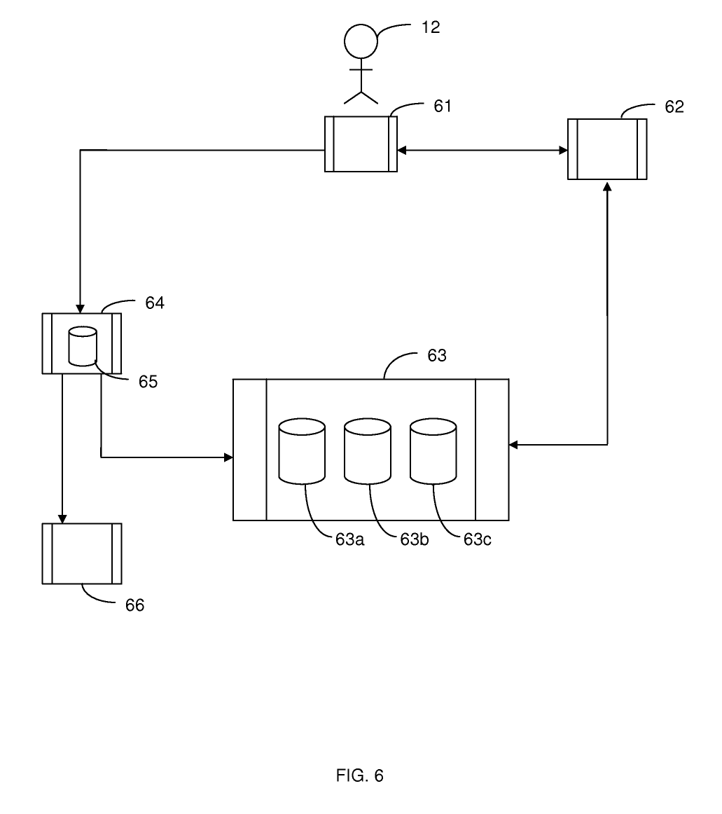

A “dumb” ATM is an ATM that is only capable of receiving input from a user, asking the ATM processor if it can take action on the data, and executing or denying the transaction based on the ATM processor's response. Most currently-deployed ATMs are dumb ATMs. Referring to FIGS. 6 and 7, the purchaser 12 maintains a checking account 63a with a bank 63. The bank 63 provides online account management services for the checking account at its website. The bank 63 provides prepaid accounts through the purchase of prepaid instruments 11 at its branches and at some of its ATMs. The bank provides the purchaser 12 with a prepaid account portfolio 63b in accordance with the present invention. The prepaid account portfolio 63b is part of the account management system accessible at the bank's website.

The prepaid instruments 11 include single-vendor cards and vendor chain cards issued by vendors, and open-format cards issued by the bank 63. The bank 63 also sells a prepaid product sheet 70 from its ATMs. The prepaid product sheet 70 contains a single-vendor card 71 having an instrument identifier and a value of $20, an advertising panel 72, and a coupon panel 73. The single-vendor card 71 is separable from the advertising panel at a perforated edge 71a. The prepaid product sheet 70 has a sheet identifier 70a. The prepaid product sheet 70 has dimensions similar to that of the national currency so that it can be easily dispensed from a standard ATM cassette.

The purchaser 12 attempts to purchase a prepaid product sheet 70 from an ATM 61 having a dispensing cassette that holds them. The purchaser 12 swipes his ATM card, enters his PIN, and selects the prepaid product sheet 70 from the ATM 61 menu. The ATM 61 creates a transaction identifier and transaction data structure according to the ISO 8583 standard. The transaction data structure contains the data identifying the purchaser 12, the purchase instrument identifier, the purchaser's 12 checking account identifier, a prepaid holding account 63c identifier, and the amount of the purchase, $20. The ATM 61 sends the transaction identifier and transaction data structure to the ATM processor 62, which requests the bank 63 to authorize the transaction. Upon authorization, the ATM processor 62 signals the ATM 61 that the transaction can proceed. The ATM 61 picks a prepaid product sheet 70 from the dispensing cassette. As the prepaid product sheet 70 is being dispensed, the prepaid product inventory manager 64 scans the sheet identifier 70a.

The ATM processor 62 unpacks the transaction data structure and sends a request to the bank 63 to transfer $20 from the purchaser's 12 checking account 63a to the prepaid holding account 63c. The ATM processor 62 also transmits the transaction identifier and transaction data structure to the bank 63.

Using the sheet identifier 70a, the prepaid product inventory manager 64 records that the prepaid product sheet 70 has been dispensed and looks up the prepaid instrument identifier in its prepaid products inventory database 65. The prepaid product inventory manager 64 notifies the prepaid instrument processor 66 that the single-vendor card 71 is now active, and sends the transaction identifier and prepaid instrument identifier to the bank 63.

The bank 63 uses the transaction identifier to associate the data received from the ATM processor 62, which includes data identifying the purchaser 12, with the data received from the prepaid product inventory manager 64, which includes the prepaid instrument identifier. The bank 63 creates a prepaid account and assigns it a prepaid account identifier and a starting value of $20. The bank 63 creates a new entry in the purchaser's 12 prepaid account portfolio 63b, as shown in FIG. 4, and can now provide prepaid account management services to the purchaser 12.

Example Purchase from a Smart ATM

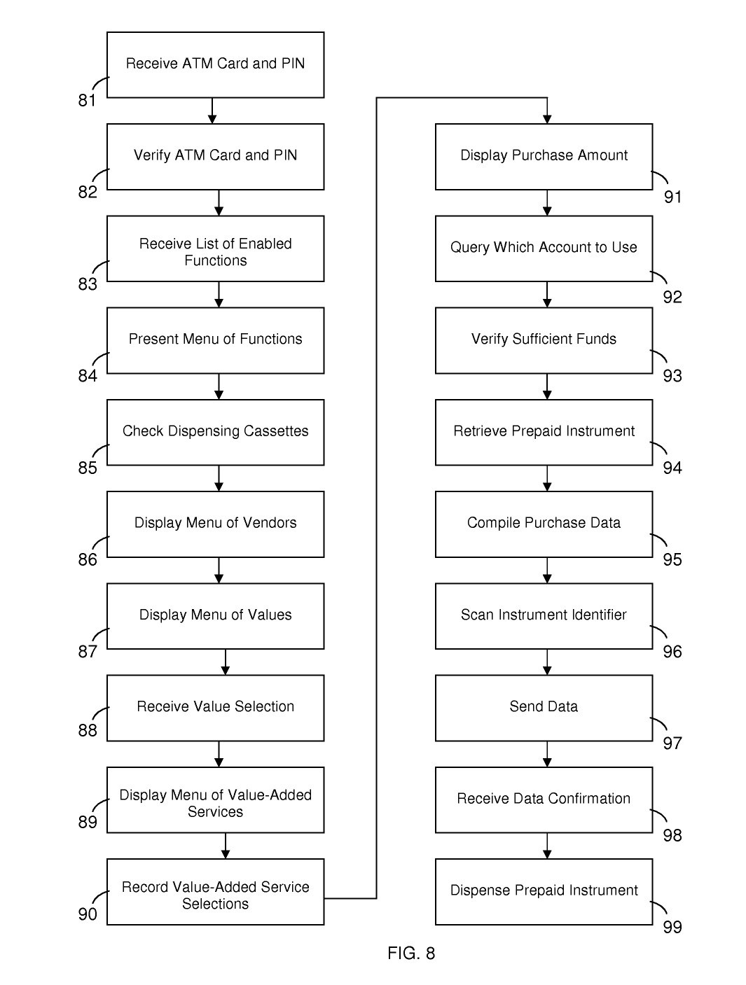

The present invention is also implemented on more sophisticated ATMs that can manage inventory and conduct complicated transactions. Referring to FIG. 8, the purchaser 12, wishing to purchase a single-vendor card for use at Vendor A's stores, engages an ATM that is configured to sell from its dispensing cassettes prepaid instruments 11, including open-format cards issued by the bank and single-vendor cards for use at Vendor A's stores, Vendor B's stores, and Vendor C's stores. The ATM receives 81 the purchaser's 12 ATM card and PIN and verifies 82 with the bank's transaction server that the PIN is correct.

If the purchaser is properly authenticated, the ATM receives a list 83 from the bank's transaction server. The list is a list of ATM functions that are enabled by the ATM card, including whether the ATM card enables the purchase of each type of prepaid instrument from the ATM. In this example, the list shows that the purchaser 12 may purchase single-vendor cards, but does not show that the purchaser 12 may purchase open-format cards. The ATM then presents 84 the purchaser 12 with a menu of buttons representing ATM functions, including “Withdrawal,” “Deposit,” “Check Balance,” and “Purchase Prepaid Card.”

When the purchaser 12 presses the “Purchase Prepaid Card” button, the ATM checks 85 if unsold single-vendor cards for all three vendors are present in their respective dispensing cassettes and notes that the dispensing cassette for Vendor B's single-vendor cards is empty. The ATM displays a vendor menu 86 with buttons for selecting one of the vendors, with the button for Vendor B marked by an out-of-stock indicator. When the purchaser presses the button for a Vendor A single-vendor card, the ATM displays a value menu 87 with buttons for selecting a card dollar value, including a button for entering an amount that is not listed. The ATM receives a signal 88 that the purchaser has selected a value of $50 for the single-vendor card.

The ATM then displays a services menu 89 that presents the available choices for value-added services that may be associated with the single-vendor card, along with the fees for each service. The ATM records 90 the purchaser's selections to have funds refunded on expiration and to add accumulated interest to the purchaser's account. The ATM then displays the total cost 91 of the single-vendor card, the number of reward points accumulated from the purchase, the expiration date of the closed-format card, and the selected options, and asks the purchaser to confirm the purchase.

Because the purchaser has only a single checking account with the bank, the ATM does not need to query 92 the purchaser to specify which account should be used to fund the prepaid account. Therefore, upon confirmation of the purchase, the ATM verifies 93 that there are sufficient funds in the checking account and then retrieves 94 a single-vendor card from Vendor A's dispensing cassette.

Before the single-vendor card is dispensed to the purchaser, the ATM compiles 95 the purchase data collected from the purchaser. The purchase data includes the purchaser's account identifier, the starting value the prepaid account, and the value-added services selected by the purchaser. The ATM also scans 96 the instrument identifier of the retrieved single-vendor card. The ATM then sends 97 the purchase data and the instrument identifier to the bank's transaction server, where the purchase data is associated with the instrument identifier. Upon receiving confirmation 98 that the purchase data was received by the bank's transaction server, the ATM dispenses 99 the single-vendor card to the purchaser 12.

Example Over-the-Counter Purchase Using Cash

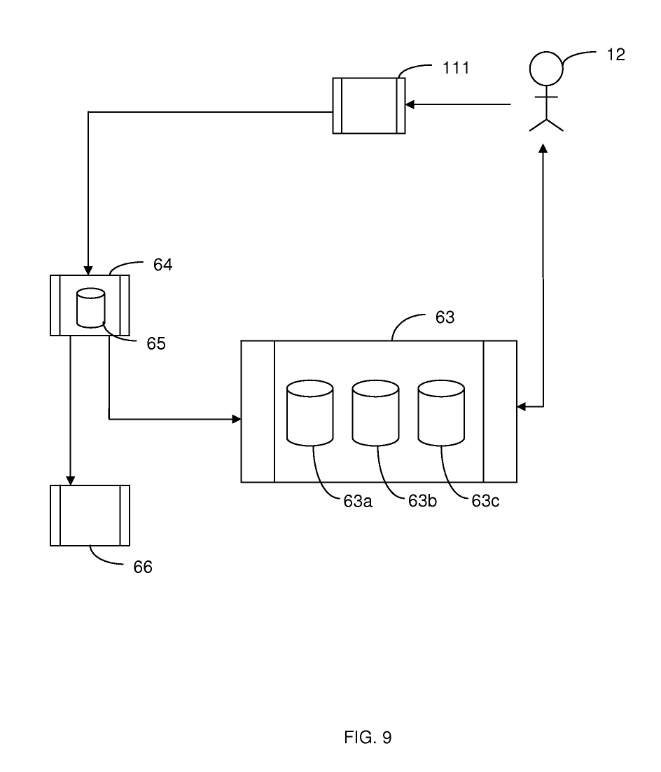

In this example, illustrated in FIGS. 7 and 9, the purchaser 12 has existing accounts with a bank 63 as described in the “Dumb ATM” example above. Non-activated prepaid products sheets 70 are sold at a grocery store, and the purchaser 12 wishes to buy a prepaid product sheet 70 with cash at the grocery store register 111. The purchaser 12 selects the prepaid product sheet 70 he wants from a sales rack and purchases it at the register 111. The register 111 scans the sheet identifier 70a and notifies the prepaid product inventory manager 64 that the prepaid product sheet 70 has been sold. The single-vendor card 71 has the instrument identifier and an activation telephone number and website address printed on it.

Using the sheet identifier 70a, the prepaid product inventory manager 64 records that the prepaid product sheet 70 has been dispensed and looks up the prepaid instrument identifier for the single-vendor card 71 in its prepaid products inventory database 65. The prepaid product inventory manager 64 notifies the prepaid instrument processor 66 that the single-vendor card 71 has been purchased, and sends the prepaid instrument identifier to the bank 63. The prepaid instrument processor 66 activates the single-vendor card 71. The bank 63 creates a prepaid account and assigns it a prepaid account identifier and a starting value. At this point, the single-vendor card 71 may be used for purchases, but these purchases would not be tracked in the purchaser's 12 prepaid account portfolio.

The purchaser 12 calls the telephone number on the single-vendor card 71, connecting him with the bank 63, in order to be linked 22 with the single-vendor card 71. The purchaser 12 provides identifying information to the bank agent to gain access to his checking account 63a. The purchaser 12 then reads the instrument identifier to the bank agent. The bank 63 creates a new entry in the purchaser's 12 prepaid account portfolio 63b, as shown in FIG. 4, and stores the instrument identifier in the entry. The bank 63 can now provide prepaid account management services to the purchaser 12.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

We claim:

1. A method for managing prepaid accounts, the method comprising using a computer to associate a prepaid instrument with a purchaser of the prepaid instrument.

2. The method of claim 1 wherein associating the prepaid instrument with the purchaser of the prepaid instrument comprises:
a) receiving a prepaid instrument identifier identifying the prepaid instrument;
b) associating the prepaid instrument with a prepaid account;
c) receiving purchase data comprising data identifying the purchaser; and
d) linking the purchaser to the prepaid account, the linking comprising:
i. identifying the purchaser's prepaid account portfolio using the data identifying the purchaser;
ii. creating a prepaid account record in the purchaser's prepaid account portfolio; and
iii. storing the prepaid account identifier and the prepaid instrument identifier in the prepaid account record.

3. The method of claim 2 wherein using the prepaid instrument identifier and the purchase data to link the purchaser to the prepaid account further comprises storing the purchase data in the prepaid account record.

4. The method of claim 3 wherein the purchase data further comprises a stored value.

5. The method of claim 4 wherein the prepaid account is a deposit account containing funds equal to the stored value.

6. The method of claim 4 wherein the prepaid account tracks the stored value, and funds equal to the stored value are held in a prepaid holding account.

7. The method of claim 4 wherein the stored value is an amount of currency, the method further comprising reindexing the stored value at a predetermined interval to counteract currency inflation.

8. The method of claim 4 wherein the stored value is an amount of a particular commodity.

9. The method of claim 2 wherein the prepaid instrument identifier and purchase data are received from the purchaser.

10. The method of claim 2 wherein the purchase data is received from a point-of-sale device.

11. The method of claim 10 wherein the point-of-sale device is an automated teller machine (“ATM”).

12. The method of claim 11 further comprising:
a) receiving a transaction identifier generated by the ATM during the purchaser's purchase of the prepaid instrument, the transaction identifier being associated with the prepaid instrument identifier before it is received; and
b) receiving a transaction data structure, the transaction data structure being associated with the transaction identifier before the transaction data structure is received, wherein the transaction data structure:
i. is generated by the ATM during the purchaser's purchase of the prepaid instrument;
ii. is identified by the transaction identifier; and
iii. comprises the purchase data; and
c) using the transaction identifier to associate the prepaid instrument identifier with the purchase data.

13. The method of claim 12 wherein the prepaid instrument is part of a prepaid product bundle having a bundle identifier.

14. The method of claim 13 wherein receiving the prepaid instrument identifier comprises:
a) receiving the bundle identifier from the point-of-sale device; and
b) using the bundle identifier to determine the prepaid instrument identifier.

15. The method of claim 2 wherein the prepaid account has an expiration date and a stored value, the method further comprising returning funds equivalent to the stored value to the purchaser on or after the expiration date.

16. The method of claim 2 wherein the prepaid account has a stored value, the method further comprising returning funds equivalent to the stored value to the purchaser if the prepaid instrument is lost or stolen.

17. The method of claim 2 further comprising:
a) receiving transaction details describing a purchase made using the prepaid instrument; and
b) adding the transaction details to the prepaid account record.

18. The method of claim 17 further comprising providing the transaction details to the purchaser.

19. The method of claim 2 further comprising displaying a visual representation of the prepaid account portfolio to the purchaser, the visual representation comprising data contained in the prepaid account record.

20. A prepaid account management system comprising a prepaid account provider having a central data server and a transaction server, the prepaid account provider configured to:
a) receive, on the transaction server, a prepaid instrument identifier identifying a prepaid instrument;
b) receive, on the transaction server, purchase data comprising data identifying a purchaser of the prepaid instrument;
c) identify the purchaser's prepaid account portfolio on the central data server;
d) create a prepaid account identifier for a prepaid account; and
e) link the purchaser to the prepaid account, the linking comprising:
i. creating a prepaid account record in the purchaser's prepaid account portfolio; and
ii. storing the prepaid account identifier and the prepaid instrument identifier in the prepaid account record.

21. The prepaid account management system of claim 20 further comprising a point-of-sale device in electronic communication with the prepaid account provider, the point-of-sale device being configured to:
a) scan the prepaid instrument identifier on the prepaid instrument;
b) collect the purchase data;
c) dispense the prepaid instrument to the purchaser; and
d) transmit the prepaid instrument identifier and the purchase data to the prepaid account provider.

22. The prepaid account management system of claim 20 wherein the prepaid instrument is a part of a prepaid product bundle, the system further comprising:
a) a point-of-sale device in electronic communication with the prepaid account provider, the point-of-sale device configured to:
i. scan a bundle identifier on the prepaid product bundle;
ii. collect the purchase data;
iii. dispense the prepaid product bundle to the purchaser;
iv. transmit the purchase data to the prepaid account provider; and
v. transmit the bundle identifier; and
b) a prepaid products inventory manager in electronic communication with the prepaid account provider and the point-of-sale device, the prepaid products inventory manager configured to:
i. receive the bundle identifier from the point-of-sale device;
ii. use the bundle identifier to determine the prepaid instrument identifier; and
iii. transmit the prepaid instrument identifier to the prepaid account provider.

23. The prepaid account management system of claim 22 wherein:
a) the point-of-sale device is an automated teller machine (“ATM”);
b) the point-of-sale device is further configured to generate a transaction identifier and to transmit the transaction identifier to:
i. the prepaid account provider with the purchase data; and
ii. the prepaid products inventory manager with the bundle identifier;
c) the prepaid products inventory manager is further configured to transmit the transaction identifier to the prepaid account provider with the prepaid instrument identifier; and
d) the prepaid account provider uses the transaction identifier to associate the prepaid instrument identifier with the purchase data.
